(19) United States
(12) Patent Application Publication
(10) Pub. No.: US 2019/0056169 A1
(43) Pub. Date: Feb. 21, 2019

(54) OUTER PLATE OF REFRIGERATOR AND METHOD FOR MANUFACTURING THE SAME

(71) Applicant: LG ELECTRONICS INC., Seoul (KR)

(72) Inventors: Seokyong HONG, Seoul (KR); Youngwoo KIM, Seoul (KR); Hyesun JUNG, Seoul (KR)

(73) Assignee: LG Electronics Inc.

(21) Appl. No.: 16/106,757

(22) Filed: Aug. 21, 2018

(30) Foreign Application Priority Data
Aug. 21, 2017 (KR) 10-2017-0105167

(51) Int. Cl. F25D 23/06; B05D 7/00; B05D 5/02

(52) U.S. Cl. CPC F25D 23/06; F25D 2400/18; B05D 5/02; B05D 7/5383

(57) ABSTRACT

Provided is an outer plate of a refrigerator. The outer plate of the refrigerator includes a steel plate made of a stainless steel material and having a front surface on which a hairline is processed, a primer layer disposed on the front surface of the steel plate so as to have a color and configured to couple adjacent layers to each other, and a clear coating layer transparently disposed on a top surface of the primer layer and configured to protect the primer layer and define an outer appearance of an outer surface. Paint for forming the primer layer includes a nano pigment realizing a color while maintaining transparency of the primer layer and an adhesion promoter for the adhesion between the steel plate and the coating layer. When viewed from the outside of the refrigerator, the color of the primer is expressed, and the hairline is visible through the primer layer and the clear coating layer.

### CROSS-REFERENCE TO RELATED APPLICATIONS

The present application claims priority under 35 U.S.C. 119 and 35 U.S.C. 365 to Korean Patent Application No. 10-2017-0105167 (filed on Aug. 21, 2017), which is hereby incorporated by reference in its entirety.

### BACKGROUND

The present disclosure relates to an outer plate of a refrigerator and a method for manufacturing the same.

In general, refrigerators are home appliances for storing foods at a low temperature in a storage space that is covered by a door. Here, the storing space is cooled using cool air that is generated by heat-exchanging with a refrigerant circulating a refrigeration cycle to store the foods in an optimal state.

The inside of the refrigerator may be classified into a refrigerating compartment and a freezing compartment. Accommodation members such as shelves, drawers, and baskets may be disposed within the refrigerating compartment and the freezing compartment. Also, each of the refrigerating compartment and the freezing compartment may be closed by a door. The refrigerator is classified into various types according to positions of the refrigerator compartment and the freezer compartment and configurations of the doors.

The refrigerator tends to increase in size more and more, and multi-functions are provided to the refrigerator as dietary life changes and pursues high quality, and accordingly, refrigerators having various structures and including convenience devices in consideration of user convenience are being developed, and also, refrigerators having elegant and various outer appearances are being brought to the market.

For example, an electronic product in which a fingerprint resistance coating layer is formed on a surface of a housing made of a metal base material on which a hairline is processed is disclosed in Korean Patent Publication No. 10-2017-0073278.

However, in the technique according to the related art, if no color is formed on the base material on which the outer hairline is formed, when a color layer is formed on a surface to impart a color, the hairline is not exposed to the outside but is covered. Thus, the proper texture of the metal represented by the hairline may not be realized.

In addition, when the color layer is formed to form the color on a top surface on which the hairline is formed, a surface of the color layer may be damaged by scratch due to external contact. Particularly, such limitations may be more serious in refrigerator which frequently comes into contact with a user.

### SUMMARY

Embodiments provide an outer plate of a refrigerator, in which a hairline for realizing texture of a metal and a color are realized at the same time and a method for manufacturing the same.

Embodiments also provide an outer plate of a refrigerator, in which a color layer is protected, and a hairline is exposed to the outside, and a method for manufacturing the same.

In one embodiment, an outer plate of a refrigerator includes: a steel plate made of a stainless steel material and having a front surface on which a hairline is processed; a primer layer disposed on the front surface of the steel plate so as to have a color and configured to couple adjacent layers to each other; and a clear coating layer transparently disposed on a top surface of the primer layer and configured to protect the primer layer and define an outer appearance of an outer surface, wherein paint for forming the primer layer includes a nano pigment realizing a color while maintaining transparency of the primer layer and an adhesion promoter for the adhesion between the steel plate and the coating layer, and when viewed from the outside of the refrigerator, the color of the primer is expressed, and the hairline is visible through the primer layer and the clear coating layer.

The hairline may be provided so that the steel plate has a surface roughness of about 8.0 Ra to about 1.1 Ra.

The nano pigment may have particles having a black color or a black-like color, each of which has a size of several ten nanometers to several hundred nanometers.

The paint for forming the primer layer may use polyester as a main resin and include a melamine-based cross linker, the adhesion promoter, and the nano pigment for realizing the color, and the nano pigment may contain a content of about 12% to about 15% with respect to the total amount of the paint.

The primer layer may have a thickness of about 4 μm to about 6 μm.

A non-chromate layer that prevents the hairline-processed portion from corroding and has chemical resistance may be provided on the front surface of the steel plate on which the hairline is provided, and the primer may be disposed on a front surface of the non-chromate layer.

The paint forming the clear coating layer may be made of an acrylic resin material that satisfies a molecular weight of about 6,000 to about 8,000 and a glass transition temperature of about 60 Tg(° C.).

A matting agent having particles for diffusely reflecting incident light to reduce gloss of the outer plate may be added to the paint for forming the clear coating layer.

Paint for forming the clear coating layer may use acryl as a main resin and include a melamine-based cross linker and a matting agent for reducing gloss of the clear coating layer, and the matting agent may contain a content of about 2% to about 3% with respect to the total amount of the paint.

The clear coating layer may have a thickness of about 3 μm to about 4 μm.

The matting agent may have particles, each of which has a size of about 3 μm or less.

The clear coating layer may have gloss of about 40% to about 50%.

In another embodiment, a method for manufacturing an outer plate of a refrigerator, which includes: a steel plate made of a stainless steel material and having a front surface on which a hairline is processed; a primer layer disposed on the front surface of the steel plate so as to have a color and configured to couple adjacent layers to each other; and a clear coating layer transparently disposed on a top surface of the primer layer and configured to protect the primer layer and define an outer appearance of an outer surface, wherein paint for forming the primer layer includes a nano pigment realizing a color while maintaining transparency of the primer layer and an adhesion promoter for the adhesion between the steel plate and the coating layer, and when viewed from the outside of the refrigerator, the color of the primer is expressed, and the hairline is visible through the primer layer and the clear coating layer, includes: incoming the roll-type steel plate; forming the hairline on the front surface of the steel plate; forming a primer layer formed on the front surface of the steel plate, on which the hairline is formed, having an outer appearance color through which the hairline is visible, and adhering to an adjacent layer; and forming a clear coating layer formed on a front surface of the primer layer to protect the primer layer and defining an outer appearance.

The paint for forming the primer layer may include: a pigment having a black color or a black-like color while the hairline is visible; and an adhesion promoter adhering between the steel plate and the clear coating layer.

In the forming of the hairline, the steel plate that is wound in a roll type may be continuously supplied, and a belt-type processing member rotating by a processing roller may contact the front surface of the steel plate to continuously form the hairline.

The steel plate may be supplied in a state of being wound in a roll type, and the primer layer and the clear coating layer may be continuously formed in a roll manner.

The processing member may include: a belt; and an abrasive provided on one surface of the belt and made of aluminum oxide material.

The processing member may form the hairline so that the steel plate has a surface roughness of about 8.0 Ra to about 1.1 Ra.

A matting agent for reducing gloss of the clear coating layer may be added to the paint for forming the clear coating layer, and the matting agent may have particles, each of which has a size of about 3 μm or less.

The method according may further include a non-chromate layer having corrosion resistance and chemical resistance on the front surface of the steel plate on which the hairline is provided, wherein the non-chromate layer may be formed by continuously supplying the roll-type steel plate on which the hairline is formed.

The details of one or more embodiments are set forth in the accompanying drawings and the description below. Other features will be apparent from the description and drawings, and from the claims.

### BRIEF DESCRIPTION OF THE DRAWINGS

FIG. 1 is a front view of a refrigerator according to an embodiment.

FIG. 2 is an exploded perspective view of the door of the refrigerator.

FIG. 3 is a schematic view illustrating a configuration of an outer plate of the refrigerator according to an embodiment.

FIG. 4 is a view sequentially illustrating a method for manufacturing an outer plate of a refrigerator.

FIG. 5 is a schematic view illustrating a process of processing a hairline of the outer plate of the refrigerator.

### DETAILED DESCRIPTION OF THE EMBODIMENTS

Hereinafter, detailed embodiments of the present disclosure will be described in detail with reference to the accompanying drawings. However, the scope of the present disclosure is not limited to proposed embodiments, and other regressive inventions or other embodiments included in the scope of the spirits of the present disclosure may be easily proposed through addition, change, deletion, and the like of other elements.

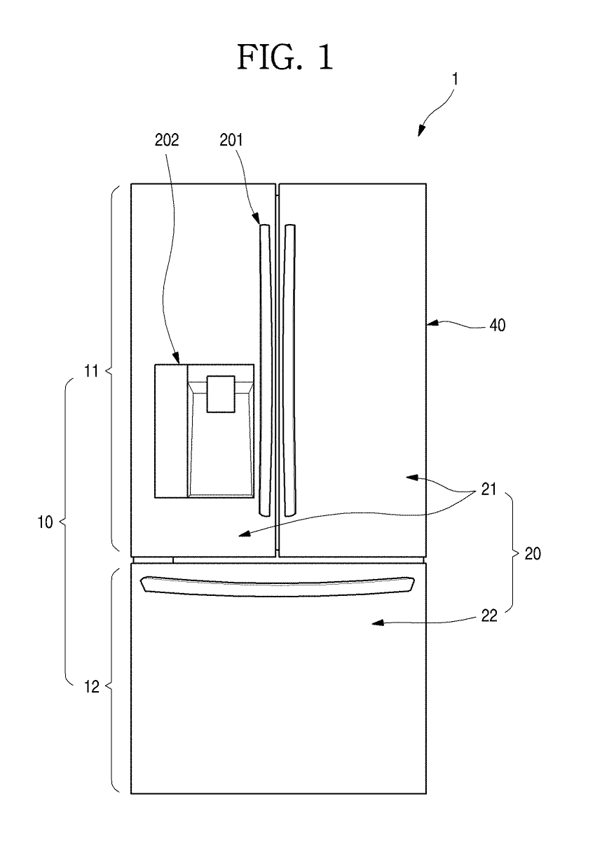

FIG. 1 is a front view of a refrigerator according to an embodiment.

As illustrated in the drawing, a refrigerator 1 according to an embodiment includes a cabinet 10 defining a storage space and a door 20 mounted on a front surface of the cabinet 10. Here, an outer appearance of the refrigerator 1 is defined by the cabinet 10 and the door 20.

The inside of the cabinet 10 may be partitioned into a plurality spaces. As illustrated in the drawing, the inside of the cabinet 10 may be partitioned into two spaces to define a refrigerating compartment 11, which is provided at an upper side, and a freezing compartment 12, which is provided at a lower side.

Also, the door 20 may include a refrigerating compartment door 21 and a freezing compartment door 22, which respectively independently open and close the refrigerator compartment 11 and the freezer compartment 12. The refrigerating compartment door 21 may be provided in a pair at both left and right sides to open and close the whole or a portion of the refrigerating compartment 11 through rotation thereof. Also, the freezing compartment door 22 may be inserted and withdrawn in a drawer manner.

The configuration and arrangement of the storage spaces and the shape of the door 20 may be variously changed in addition to those shown in the drawing.

The door 20 may define an outer appearance of the front surface of the refrigerator 1 in a state in which the door 20 is closed. Also, the refrigerator 1 may have a structure of which the entire front surface is exposed to the outside due to installation characteristics. Thus, most of the outer appearance visible by a user may be defined by the door 20.

A door handle 201 that facilitates the opening/closing of the door 20 may be provided on the door 20. Also, a dispenser 202 through which water or ice is dispensed to the outside may be provided in one door of the plurality of doors 20.

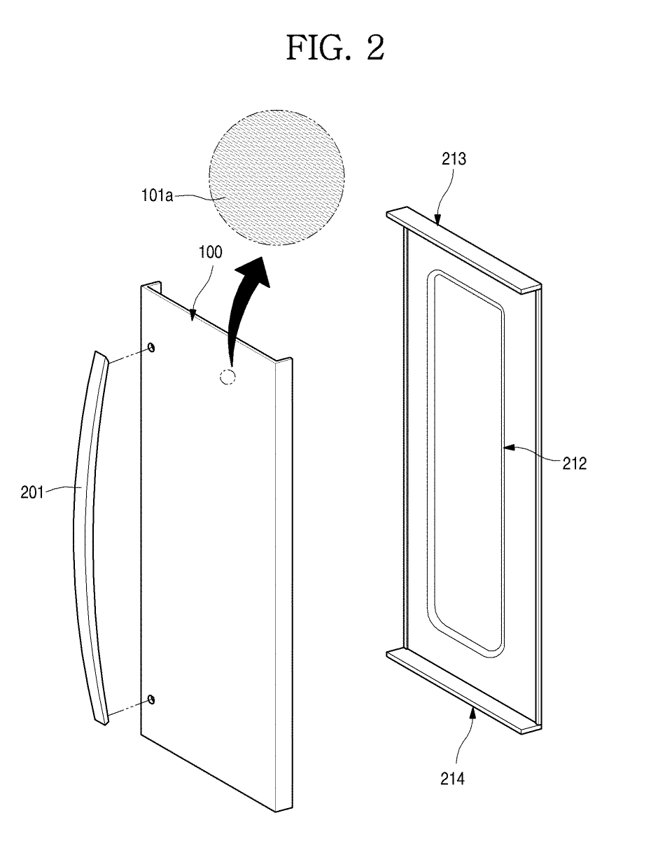

FIG. 2 is an exploded perspective view of the door of the refrigerator.

A structure of the door will now be described in more detail with reference to the drawings. For convenience of description, although the right door of the refrigerating compartment doors 21 has been described as an example in FIG. 2, the structure may be applied to all types of refrigerator doors.

The door 20 may include an outer plate 100 defining an outer appearance of the front surface thereof and a door liner 212 coupled to the outer plate 100 to define an outer appearance of a rear surface thereof. Also, top and bottom surfaces of the door 20 may be defined by an upper deco 213 and a lower deco 214, respectively.

The outer plate 100 may have a plate shape and be made of a metal material to define the front surface and a portion of a circumferential surface of the door 20. For example, as illustrated in FIG. 2, both ends of the outer plate 100 may be bent to define at least portions of both surfaces of the door 20.

The outer plate 100 may be made of an actual metal material such as stainless steel to realize an elegant outer appearance of the refrigerator. Also, to maximize real texture of the metal, a pattern of a hairline may be provided on the outer plate 100 so that the pattern of the hairline 111a is visible from the outside. Also, the outer plate 100 may have a non-glossy black color to produce a more luxurious image. The outer plate 100 is not limited to the black color but may include dark colors similar to black, for example, s blue black color, a black brown color, a red black color, a dark navy color, a dark brown color, and the like.

The door handle 201 may be mounted on a front surface of the outer plate 100. The door handle 201 may have a bar shape. Also, upper and lower ends of the door handle 201 may be fixed to the outer plate 100, and at least a portion between the upper and lower ends may be spaced apart from the front surface of the outer plate 100 so that the user easily holds the door handle 201.

The door liner 212 may be made of a plastic material and define an outer appearance of a rear surface of the door 20. The door liner 212 may be formed to have a structure a gasket or a shelf mounted on the rear surface of the door 20 is capable of being mounted. A door dike vertically extending from both side ends may be disposed on the door liner 212. To realize such a complicated shape, the door liner 212 may be injection-molded with a plastic material.

The upper deco 213 may be coupled to an upper end of the outer plate 100 and an upper end of the door liner 212 to define the top surface of the door 20. The lower deco 214 may also be injection-molded with a plastic material.

The lower deco 214 may be coupled to a lower end of the outer plate 100 and a lower end of the door liner 212 to define the bottom surface of the door 20. The lower deco 214 may also be injection-molded with a plastic material.

A space may be defined in the door 20 by coupling the outer plate 100 to the door liner 212 and coupling the upper deco 213 to the lower deco 214. An insulation material (not shown) may be provided in the space. The insulation material may be formed by injecting a foam solution and be completely filled into the door 20 to allow the door 20 to be insulated. Thus, in the state in which the door is closed, the inside of the storage space may be insulated to maintain cold air within the refrigerator.

The structure of the outer plate 100 that defines the most of the outer appearance of the refrigerator 1, which is exposed to the outside in the state in which the door 20 is closed, will be described in more detail with reference to the accompanying drawings.

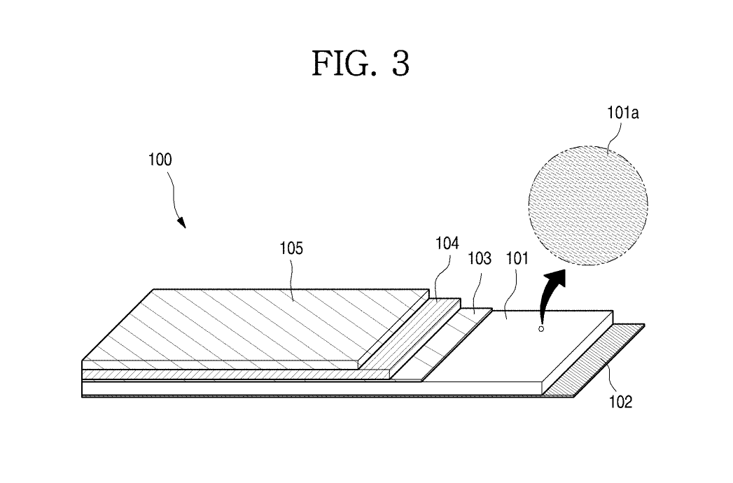

FIG. 3 is a schematic view illustrating a configuration of an outer plate of the refrigerator according to an embodiment.

Hereinafter, a surface of the outer plate 100 in a direction that is directed toward the outside of the refrigerator with respect to the outer plate 100 may be defined as a front surface, and a surface of the outer plate 100 in a direction that is directed toward the inside of the refrigerator with respect to the outer plate 100 may be defined as a rear surface. Also, the front surface may be called a top surface, and the rear surface may be called a bottom surface.

As illustrated in the drawing, the outer plate 100 may generally include a steel plate 101 made of a metal material, a primer layer 104 disposed on a top surface of the steel plate 101, and a clear coating layer 105 attached to the primer layer 104.

The outer plate 100 may have a black color of a black-like dark color. To realize a more luxurious appearance, the outer plate 100 may have a gloss of about 40% to about 50% (if a completely transparent state is 100%). Also, the hairline pattern may be exposed on the front surface of the outer plate 100 to realize more elegant metal texture. That is, the outer appearance of the front surface of the refrigerator 1 may be defined by the outer plate 100 and may be seen as the black matte metal material with the hairline pattern.

In detail, the steel plate 101 may be made of a stainless steel material as a main component of the outer plate 100. The steel plate 101 may be made of a STS201 material to realize elegant texture. Also, the steel plate 101 may not have magnetism to provide feeling of real stainless steel to the user.

Also, the hairline 101a may be disposed on a surface of the steel plate 101, i.e., the surface that is directed toward the outside of the refrigerator. The hairline 101a may maximize the real metal texture of the outer plate 100 and have a fine size on the steel plate 101. Also, the hairline 101a may be continuously processed on the roll-type steel plate 101.

Since the hairline 101a is provided, the steel plate 101 may be processed so that a surface roughness (Ra: arithmetic average roughness) of the steel plate 111 is approximately 0.8 Ra to 1.1 Ra. Thus, the hairline 101a may be visible from the outside through the primer layer 104 and the clear layer 105. Particularly, in this embodiment, the hairline 101a may be sufficiently visible to provide the metal texture to the user even on a matte surface.

A back coating layer 102 may be disposed on a rear surface of the steel plate 101. The back coating layer 102 may be a portion defining the rear surface of the outer plate 100. Also, the back coating layer 102 may be exposed to the outside when the steel plate 101 or the outer plate 100 is supplied. Thus, the back coating layer 102 may be applied to the rear surface of the steel plate 101 to provide corrosion resistance and/or chemical resistance, thereby providing corrosion and chemical stability of the steel plate 101. The back coating layer 102 may be formed while the steel plate 101 is molded. When the steel plate 101 incomes in a roll type, the steel plate 101 may income in a state of being formed on the rear surface of the steel plate 101.

Also, a non-chromate layer 103 may be disposed on the surface of the steel plate 101 on which the hairline 101a is processed. The non-chromate layer 103 may be applied to the surface of the steel plate 101 in a preprocessing process after the hairline 101a of the steel plate 101 is processed with a thin film of oxide or inorganic salt on the surface of the steel plate 101. The non-chromate layer 103 may have corrosion resistance and chemical resistance to protect the surface of the steel plate 101 on which the hairline 101a is processed. Also, the adhesion of the primer layer 104 may be further improved by the non-chromate layer 103. The non-chromate layer 103 may be omitted as necessary.

The primer layer 104 may be disposed on the front surface on which the hairline 101a is provided, i.e., a front surface of the non-chromate layer 103. The primer layer 104 may allow the clear coating layer 105 to adhere to the steel plate 101 and simultaneously express the color of the outer plate 100. Thus, the primer layer 104 may be called a color layer.

In detail, the primer layer 104 may have a thickness of about 4 μm to about 6 μm. When the primer layer 104 has a thin thickness of about 4 μm or less, it may be difficult to sufficiently realize the black color. When the primer layer 121 has a thickness of about 6 μm or more, the hairline 101a, which is disposed at a lower side, may not be exposed or may be unclearly visible.

The primer layer 104 may perform the adhesion function and the color realization function at the same time. Paint for forming the primer layer 104 uses polyester as a main resin and include a melamine-based cross linker. Also, an adhesion promoter may be added to the paint so that the steel plate 101 and the clear coating layer 105 adhere to each other.

Particularly, in the primer layer 104, a nano pigment may be used to realize the color or secure transparency. The nano pigment may be contained at a content of about 12% to about 15% with respect to the total amount of the pigment for applying the primer layer 104. Here, when the nano pigment is contained at a content of about 12% or less, the realization of the black color of the outer plate 100 may not be satisfied. When the nano pigment is contained at a content of about 15% or more, the hairline 101a may be covered and thus may not be sufficiently visible from the outside.

The black color of the primer layer 104 may be realized through the nano pigment, and simultaneously, the hairline 101a disposed below the primer layer 104 may be visible from the outside through the primer layer 104. As described above, the nano pigment may have a nano size of several ten nanometers to several hundred nanometers to realize the black color and also may have transparency so that the hairline 101a disposed below the primer layer 104 is visible. Thus, the color may be realized on the layer for the adhesion by the primer layer 104 without adding a separate layer for realizing the color. That is, the primer layer 104 may realize the adhesion and the color at the same time.

The clear coating layer 105 may be disposed on the front surface of the primer layer 104. The clear coating layer 105 may be transparent and thus be called a transparent coating layer. The clear coating layer 105 may define the surface of the outer plate 100, protect the primer layer 104 for realizing the color, and protect the surface of the steel plate on which the hairline 101a is provided. Also, the outer appearance of the outer plate 100 may be seen as a matte state.

Due to the characteristics of the refrigerator door 20, frequent contact with a user's human body or a food container may not be avoided. Due to such characteristics of the refrigerator door 20, the outer plate 100 may have a suitable hardness.

Particularly, the clear coating layer for protecting the surface of the outer plate 100 may be provided in addition to the primer layer 104 to prevent a layer for realizing the color or a portion for realizing texture from being damaged by scratch. That is, when external scratch occurs, the primer layer 104, which is protected by the clear coating layer 105 to realize the color, and the hairline 101a may be prevented from being directly damaged.

The clear coating layer 105 may have to satisfy a hardness condition used for the outer appearance of the refrigerator door 20 and also satisfy fingerprint resistance so that stain such as a fingerprint does not remain on the surface of the outer plate 100 even when the user frequently contacts the clear coating layer 105.

For this, the paint for forming the clear coating layer 105 may use an acrylic resin as a main resin and include a melamine-based cross linker. Here, the acrylic resin may have a molecular weight of about 6,000 to about 8,000 to satisfy hardness, processability, and linearity and have a glass transition temperature of about 60 Tg(° C.).

Also, the clear coating layer 105 may have glass of about 40%. For this, a matting agent of about 2% to about 3% with respect to the total amount of the paint may be used in the paint for forming the clear coating layer 105 as an additive to realize a matte effect. Also, silica may be used as the matting agent.

Also, the clear coating layer 105 may have a thickness of about 3 μm to about 4 μm. The matting agent added to the clear coating layer 105 may reduce gloss through diffused reflection of light and have a particle size of about 3 μm or less. Thus, the clear coating layer 105 may have a thickness of about 3 μm or more so that the clear coating layer 105 has a thickness enough to enable the matting agent to be added. However, when the thickness of the clear coating layer 105 is excessively thicker, the clear coating layer 105 may be away from the primer layer 104 that expresses the color to cause color heterogeneity and also may be away from the hairline 101a to cause heterogeneity. Thus, the clear coating layer may have a thickness of about 4 μm or less so that the addition of the matting agent is enabled.

Hereinafter, a method for manufacturing an outer plate of a refrigerator having the above-described structure according to an embodiment will be described with reference to the accompanying drawings.

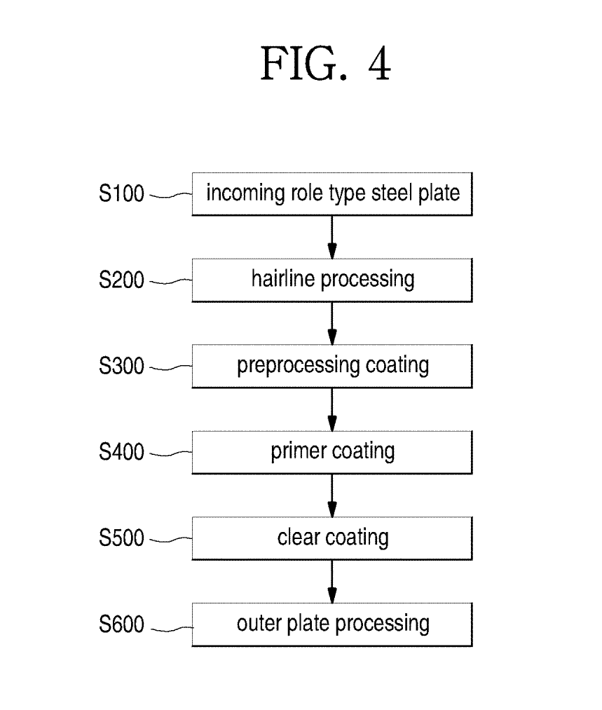

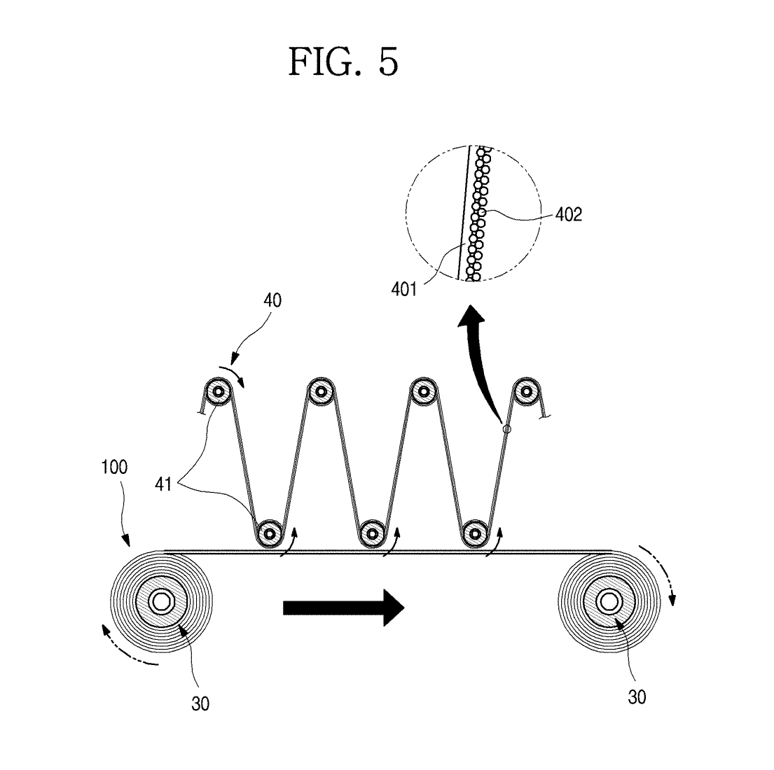

FIG. 4 is a view sequentially illustrating a method for manufacturing an outer plate of a refrigerator. FIG. 5 is a schematic view illustrating a process of processing a hairline of the outer plate of the refrigerator.

As illustrated in the drawings, to manufacture the outer plate 100, the steel plate 101 that is wound in a roll type may income first. The steel plate 101 may income in a roll state so that continuous processing is performed by using a stainless steel material.

Also, when the steel plate 101 incomes, the steel plate 101 may income in a state in which a back coating layer 102 is formed on a rear surface of the steel plate 101. That is, the back coating layer 102 may be supplied in a state of being formed by the manufacturer of the stainless steel plate [S100].

A hairline 101a may be processed on a front surface of the steel plate 101 that is in the roll state. The steel plate 101 may be continuously wound through a pair of transfer rollers 30. The steel plate 101 may contact a hairline processing member 40 disposed between the pair of transfer rollers 30 to process the hairline 101a on the surface of the steel plate 111.

The hairline processing member 40 may be provided in a belt type and rotatable while maintaining set tension by a plurality of processing rollers 41. Here, a portion of the rotating hairline processing member 40 may contact the surface of the steel plate 101, and the hairline 101a may be processed by an unevenness formed on a surface of the hairline processing member 40.

In more detail, as illustrated in FIG. 5, the hairline processing member 40 may have a belt structure having a predetermined area and form the hairline 101a by friction with the surface of the steel plate 101. Thus, the hairline processing member 40 may be called a sand paper. The hairline processing member 40 may be constituted by a belt 401 made of a fabric material and an abrasive 402 attached to one surface of the belt 401.

The belt 401 may have a length and width at which the belt 401 is capable of being installed on the processing roller 41 and may have a width corresponding to that of the steel plate 101. The belt 401 may be made of various materials that are capable of continuously processing the surface of the steel plate while maintaining the set tension as well as the fabric material.

The abrasive 402 may be made of aluminum oxide so that a surface roughness of the steel plate 101 has a set surface roughness (about 8 Ra to about 1.1 Ra) by the hairline 101a formed on the surface of the steel plate 101. The aluminum oxide may have a spherical crystal structure, and it may be possible to process a deep and clear hairline on the surface of the stainless steel having relatively high strength. Thus, the hairline 101a of the steel plate 101 may be clearly visible from the outside even in a state in which a primer layer 104 and a clear coating layer 105 are disposed at a front side thereof.

Also, the abrasive 402 may be attached to be multilayered on the belt 401 so that continuous processing is performed by the processing roller 41. Thus, even when the steel plate 101 is continuously supplied, the hairline processing member 40 may also rotate to contact the surface of the steel plate 101, thereby continuously forming the hairline 101a [S200].

After the hairline 101a is continuously processed on the surface of the steel plate 101, preprocessing coating may be performed to form a non-chromate layer 103. The preprocessing coating may be performed for applying the non-chromate 103 on the surface of the steel plate 101 on which the hairline 101a is formed. The preprocessing coating may be performed to form a thin film, thereby improving the adhesion between the steel plate 101 and the primer layer 104 and protecting the surface of the steel plate 101, on which the hairline 101a is processed. The non-chromate layer 103 may be applied to the front surface of the steel plate 101 while continuously supplying the roll-type steel plate 101 on which the hairline 101a is formed [S300].

After the non-chromate layer 103 is completely formed, the primer layer 104 may be formed on a top surface of the non-chromate layer 103. The primer layer 104 may be formed to apply paint for forming the primer layer 104. The roll-type steel plate 101 on which the non-chromate layer 103 is formed may be applied while being continuously supplied to form the primer layer 104 [S400].

After the non-chromate layer 104 is completely formed, the clear coating layer 105 may be formed on the top surface of the primer layer 104. The clear coating layer 105 may be formed by applying the paint for forming the clear coating layer 105. The roll-type steel plate 101, on which the primer layer 104 is formed, may be applied while being continuously supplied, like the coating processing of the primer layer 104, to form the clear coating layer 105 [S500].

As described above, the steel plate 101 may be continuously supplied and processed from the initial incoming to the formation of the clear coating layer 105 in the state of being wound in the roll type. That is, the steel plate 101 may be continuously processed while the steel plate 101 wound in the roll type is continuously supplied from the initial incoming of the steel plate 101 to the processing of the hairline 101a, the formation of the non-chromate layer 104, and the formation of the clear coating layer 105.

The steel plate that is completely formed may be transferred up to the clear coating layer 105 in the wound state and be cut and bent to have a size and shape corresponding to those of the outer plate 100 of the refrigerator door 20.

Also, the bent outer plate 100 may be assembled to form the refrigerator door 20. [S600]

The outer plate of the refrigerator and the method for manufacturing the same according to the embodiment may have the following effects.

The color layer for realizing the color of the outer plate may be disposed on the primer layer, and the steel plate and the clear layer may adhere to each other by the primer layer. That is, the realization of the color and the adhesion between the layers may be enabled through the primer layer. Thus, the two functions may be realized through one layer. Thus, since it is unnecessary to provide the color layer and the adhesion layer, which are separately independent from each other, the manufacturing cost may be reduced, and the productivity may be improved.

Also, the color layer for realizing the color of the outer plate may be realized on the primer layer, and the clear coating layer may be disposed on the top surface of the primer layer so that the layer for realizing the color is protected by the clear layer. Thus, even though the surface of the outer plate is damaged by the scratch occurring due to the use characteristics of the refrigerator door, the primer layer for realizing the color may be prevented from being damaged to maintain the color and texture of the refrigerator as it is.

Also, the nano pigment may be used as the pigment used for realizing the color on the primer layer, and the hairline disposed below the primer layer may be exposed to the outside through the primer layer by the pigment. Thus, the texture of the hairline may be maintained on the outer plate while the outer plate has the color.

Also, the hairline may be processed to have the set roughness so that the hairline is visible from the outside through the primer layer and the clear coating layer event though the colored primer layer is disposed above the hairline. Thus, the texture of the hairline may be maintained on the outer plate while the outer plate has the color.

In addition, the hairline processed to have the set roughness may have the higher roughness than that in the conventional hairline processing. Thus, the texture of the hairline may be visible through the clear coating layer having the matte property from the outside as it is without being blurred.

Here, since the processing member is provided in the belt type, and the abrasive made of an aluminum oxide material is attached to be multilayered on the one side of the belt, the hairline having the set roughness may be continuously processed on the surface of the steel plate to improve the productivity.

In addition, the steel plate may income in the wound roll state and continuously supplied to continuously perform the processing of the hairline and the forming of the preprocessed layer, the primer layer, and the clear coating layer. Therefore, the productivity of the outer plate may be improved.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An outer plate of a refrigerator, comprising:
a steel plate made of a stainless steel material and having a front surface on which a hairline is processed;
a primer layer disposed on the front surface of the steel plate so as to have a color and configured to couple adjacent layers to each other; and
a clear coating layer transparently disposed on a top surface of the primer layer and configured to protect the primer layer and define an outer appearance of an outer surface,
wherein paint for forming the primer layer comprises a nano pigment realizing a color while maintaining transparency of the primer layer and an adhesion promoter for the adhesion between the steel plate and the coating layer, and
when viewed from the outside of the refrigerator, the color of the primer is expressed through the clear coating layer, and the hairline is visible through the primer layer and the clear coating layer.

2. The outer plate according to claim 1, wherein the hairline is provided so that the steel plate has a surface roughness of 8.0 Ra to 1.1 Ra.

3. The outer plate according to claim 1, wherein the nano pigment has particles having a black color or a black-like color, each of which has a size of several ten nanometers to several hundred nanometers.

4. The outer plate according to claim 1, wherein the paint for forming the primer layer uses polyester as a main resin and comprises a melamine-based cross linker, the adhesion promoter, and the nano pigment for realizing the color, and the nano pigment contains a content of 12% to 15% with respect to the total amount of the paint.

5. The outer plate according to claim 1, wherein the primer layer has a thickness of 4 μm to 6 μm.

6. The outer plate according to claim 1, wherein a non-chromate layer that prevents the hairline-processed portion from corroding and has chemical resistance is provided on the front surface of the steel plate on which the hairline is provided, and the primer is disposed on a front surface of the non-chromate layer.

7. The outer plate according to claim 1, wherein the paint forming the clear coating layer is made of an acrylic resin material that satisfies a molecular weight of 6,000 to 8,000 and a glass transition temperature of 60 Tg(° C.).

8. The outer plate according to claim 1, wherein a matting agent having particles for diffusely reflecting incident light to reduce gloss of the outer plate is added to the paint for forming the clear coating layer.

9. The outer plate according to claim 1, wherein paint for forming the clear coating layer uses acryl as a main resin and comprises a melamine-based cross linker and a matting agent for reducing gloss of the clear coating layer, and
the matting agent contains a content of 2% to 3% with respect to the total amount of the paint.

10. The outer plate according to claim 9, wherein the clear coating layer has a thickness of 3 μm to 4 μm.

11. The outer plate according to claim 10, wherein the matting agent has particles, each of which has a size of 3 μm or less.

12. The outer plate according to claim 9, wherein the clear coating layer has gloss of 40% to 50%.

13. A method for manufacturing an outer plate of a refrigerator, which comprises: a steel plate made of a stainless steel material and having a front surface on which a hairline is processed;
a primer layer disposed on the front surface of the steel plate so as to have a color and configured to couple adjacent layers to each other; and a clear coating layer transparently disposed on a top surface of the primer layer and configured to protect the primer layer and define an outer appearance of an outer surface, wherein paint for forming the primer layer comprises a nano pigment realizing a color while maintaining transparency of the primer layer and an adhesion promoter for the adhesion between the steel plate and the coating layer, and when viewed from the outside of the refrigerator, the color of the primer is expressed, and the hairline is visible through the primer layer and the clear coating layer, the method comprising:
incoming the roll-type steel plate;
forming the hairline on the front surface of the steel plate;
forming a primer layer formed on the front surface of the steel plate, on which the hairline is formed, having an outer appearance color through which the hairline is visible, and adhering to an adjacent layer; and
forming a clear coating layer formed on a front surface of the primer layer to protect the primer layer and defining an outer appearance.

14. The method according to claim 13, wherein the paint for forming the primer layer comprises:
a pigment having a black color or a black-like color while the hairline is visible; and
an adhesion promoter adhering between the steel plate and the clear coating layer.

15. The method according to claim 13, wherein, in the forming of the hairline, the steel plate that is wound in a roll type is continuously supplied, and
a belt-type processing member rotating by a processing roller contacts the front surface of the steel plate to continuously form the hairline.

16. The method according to claim 15, wherein the steel plate is supplied in a state of being wound in a roll type, and the primer layer and the clear coating layer are continuously formed in a roll manner.

17. The method according to claim 15, wherein the processing member comprises:
a belt; and
an abrasive provided on one surface of the belt and made of aluminum oxide material.

18. The outer plate according to claim 15, wherein the processing member forms the hairline so that the steel plate has a surface roughness of 8.0 Ra to 1.1 Ra.

19. The method according to claim 13, wherein a matting agent for reducing gloss of the clear coating layer is added to the paint for forming the clear coating layer, and
the matting agent has particles, each of which has a size of 3 μm or less.

20. The method according to claim 13, further comprising a non-chromate layer having corrosion resistance and chemical resistance on the front surface of the steel plate on which the hairline is provided,
wherein the non-chromate layer is formed by continuously supplying the roll-type steel plate on which the hairline is formed.
